(19) United States
(12) Patent Application Publication
(10) Pub. No.: US 2005/0075994 A1
(43) Pub. Date: Apr. 7, 2005

(54) E-brain, data structure thereof and knowledge processing method therewith

(76) Inventor: Jia-Sheng Heh, Yonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/753,469

(22) Filed: Jan. 9, 2004

(30) Foreign Application Priority Data
Oct. 7, 2003 (TW) 092127875

(51) Int. Cl. G06N 5/02; G06F 17/00; G06N 5/00; G06F 15/18; G06N 3/12; G06N 3/00

(52) U.S. Cl. 706/46; 706/50; 706/13

(57) ABSTRACT

An e-brain is provided with a data structure of hierarchy knowledge map including several knowledge symbols, among which each knowledge symbol is a carrier symbol or conceptual symbol and has a unique addressing expression, with a syntagmatic chain existed between the up- and down-knowledge symbols thereof and a knowledge attribute table for recording one or more attributes each having an attribute name and an attribute value. The e-brain comprises one or more knowledge interpreters to interpret a knowledge instruction including a knowledge operator and one or more parameters, by which the attribute value is operated under a context determined by the carrier symbol.

### FIELD OF THE INVENTION

The present invention relates generally to a knowledge processing system and method, and the data structure thereof.

### BACKGROUND OF THE INVENTION

Computers have been widely used for undertaking variety of applications for speeding of tasks originally processed by human in consideration of their superior capability in storage and data processing. Even though expert system and artificial intelligence have been developed in a period of time, there are still no satisfactory results on problem-solving, knowledge operation and even automation of them. Particularly in the educational field, it is still an object for many people betaking themselves on improvement of education in both function and efficiency aspects by using computers, examples are computer-aided instruction (CAI), interactive and remote learning programs, and considerable achievements have been accomplished. However, it is a pity that the knowledge is always searched or queried passively by these developed technologies, in other words, knowledge is simply used for a database or just plays an assistant role in a system, utilization of knowledge still relies on the operation of person and hence knowledge is not highly used. Under the influence of the background, almost all improvements to prior arts were inside the scope of alleviating efficiency of a system by further using resources of a computer, generally speaking, focusing on a database or management and usage of knowledge, instead of direct processing or operation of knowledge, as exemplified by Taiwan Patent Application Nos. 86119498, 88120145, 88122829, 88122837, 89119245, 89122082 and 89123164.

The value of knowledge relies on whether knowledge is fully utilized. If knowledge can be directly operated, in addition to information supply, then a great accomplishment will be obtained for such as problem-solving and many correlated applications by using a computer system. Therefore, the present invention is directed to a knowledge operation system and method.

### SUMMARY OF THE INVENTION

An object of the present invention is to provide a knowledge operation system, as is called an e-brain.

The data structure of an e-brain comprises, according to the present invention, a knowledge map (KM) configured in a hierarchy form, in which each node is a knowledge symbol having a syntagmatic chain with its up-knowledge symbol and a unique addressing expression. A knowledge symbol includes a string, a numeral, a graphic, an image, a visual information, an animation or any representative symbol which refers to other object or intention on a computer or Internet, or a combination thereof. Each knowledge symbol has a knowledge attribute table, in which it is recorded one or more attributes, and each attribute has an attribute name and an attribute value. In addition, a knowledge symbol includes a carrier symbol or a conceptual symbol, and the carrier symbol vehicles one or more knowledge symbols whereas the conceptual symbol is a signifier. The e-brain comprises one or more knowledge interpreters to interpret knowledge instruction, and a knowledge instruction includes a knowledge operator followed by one or more parameters, by which the e-brain operates the attribute value under a context that is determined by the carrier symbol, called knowledge processing. Moreover, by such process, a new knowledge symbol can be generated from one or more existed knowledge symbols under the knowledge processing.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a knowledge map configured in a hierarchy form;

FIG. 2 shows a knowledge attribute table of a knowledge symbol;

FIG. 3 shows a learning model;

FIG. 4 shows a system block diagram of an e-brain;

FIG. 5 shows a knowledge map of physics; and

FIG. 6 shows an internal composition of a knowledge operation unit.

### DETAILED DESCRIPTION OF THE INVENTION

The present invention intends to provide a system and method to have a knowledge operation capability, beyond the scope of any conventional knowledge bases, and by which one can search knowledge from a knowledge system, utilize the obtained knowledge and generate new knowledge, so as to construct a system with problem-solving capability for applications of for example educations.

Knowledge Map

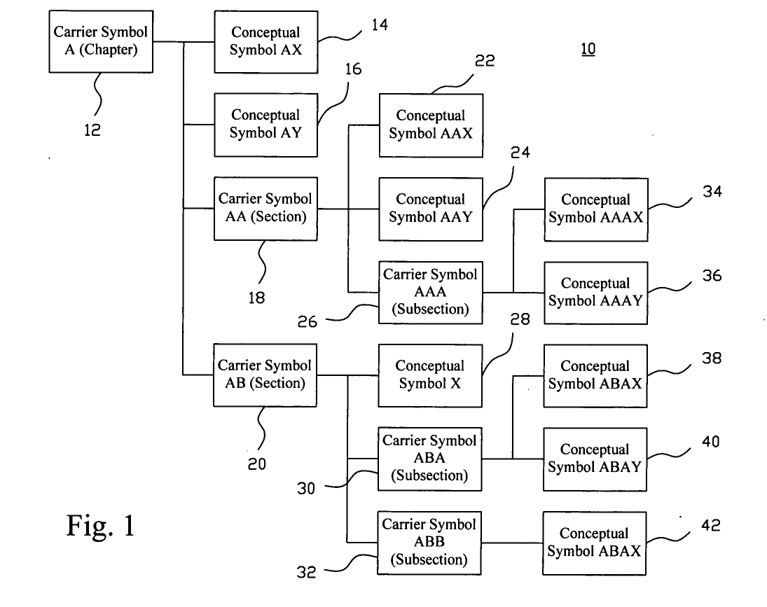

In an e-brain or a knowledge operation system, the used data structure is a knowledge map. FIG. 1 shows a knowledge map 10 according to the present invention, which has a data structure configured in a hierarchy form; namely, there is a predecessor-successor relationship among the nodes within the knowledge structure. In this knowledge map 10, each node of the hierarchy form is a knowledge symbol, as denoted by 12-42, and each of them includes a string, a numeral, a graphic, an image, a visual information, an animation or any representative symbol which refers to other object or intention on a computer or internet, or a combination thereof. These knowledge symbols 12-42 can be divided into carrier symbols or conceptual symbols. The carrier symbol per se does not directly represent a concept, but is used to vehicle knowledge symbols. Further, a carrier symbol can be used for a guiding unit so as to serve as an indication unit for knowledge symbols on the knowledge map 10, such as the chapters and sections of a book, the volumes and lessons of a course material, the countries and provinces or cities on a map, and the dynasts and dynasties or cultures and schools in a historical diagram. In the knowledge map 10, for example, the carrier symbol 12 at the root is a chapter, and the successors of the root comprise conceptual symbols 14 and 16 and carrier symbols 18 and 20, and the later two are sections under the chapter 12. Likewise, the section 18 comprises conceptual symbols 22 and 24 and a carrier symbol 26, and the later one is a subsection under the section 18. As deduced similarly from the above rules, all the knowledge symbols 12-42 constitute a knowledge (hierarchy) map 10. Also as mentioned in the above, a carrier symbol is used to vehicle a knowledge symbol, and, if necessary, a conceptual symbol can be further defined in the carrier symbol. On the other hand, the conceptual symbol is namely “a symbol to represent signification” or “a signifier”, as is generally used in semiology, such as words defined in an index, alphanumerics, drawings, notes, attitudes for dancing, colors, and costumes.

Addressing Expression

For implementation of the knowledge map 10 in a computer system or a database system, each hierarchy node, i.e., each knowledge symbol, has a unique addressing expression so as to clearly refer to any specific knowledge symbol. In one embodiment, the addressing expression for a knowledge symbol has a tree or hierarchy structure, and the title of the knowledge map, for example an optics map or a mathematics map, is the one given to the root symbol in the hierarchy. However, a knowledge map is allowed to have multiple root symbols in order to represent the most up or deepest (abstracted) fundamental symbols. Nevertheless, all the symbols on the knowledge map are expressed with a hierarchy format, such as “child symbol/parent symbol/grandparent symbol/ . . . ”. For example, if a complete title given to a symbol in the knowledge map is “AAAX/AAA/AA/A”, then the external denotation of the symbol is “AAAX/AAA/AA/A/KMAP#physics community.teaching.X junior high school”, to represent a community that is applied onto Internet. Furthermore, the parent (carrier) symbol following the title and such as the title of a community can be optionally ignored when no confusion will be generated from the ignorance, for instance, “#”, and the following title for the community can be ignored when symbols are within the same community. Briefly, some carrier symbols can be ignored in the addressing expression under specific conditions for acquiescence and consensus. The symbols used in the addressing expression can be referenced to a practical directory method in the computer system. For examples, “.”, represents the child symbol and “..” represents the parent symbol.

Syntagmatic Chain

In a knowledge map, each knowledge symbol except for the root one has some kind of syntagmatic chain with its up-knowledge symbol, such as inclusion, inheritance, amount and location.

Knowledge Attribute Table

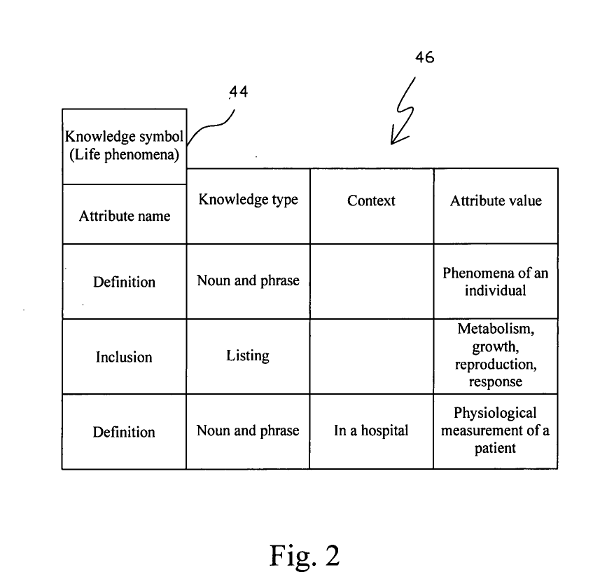

In addition to the syntagmatic chain of inclusion and inheritance described in the above, other syntagmatic characteristics of a knowledge symbol will be explained in a knowledge attribute table for the knowledge symbol. Specifically, each knowledge symbol has its own knowledge attribute table to illustrate every signified description thereof. FIG. 2 shows an exemplatory knowledge attribute table. In a knowledge symbol 44 representing life phenomena, its knowledge attribute table 46 includes for example an attribute name, a knowledge type, a context and an attribute value. Typically, each attribute of a knowledge symbol has an attribute name and an attribute value to represent one set of signified descriptions of this symbol. In the knowledge attribute table 46 of FIG. 2, each of the three attributes for the knowledge symbol 44 has a respective attribute name and attribute value. In particular, a same attribute name can have various attribute values.

Other than the syntagmatic chain, the signified descriptions of each attribute value can represent the combinational relationships among several knowledge symbols. The combinational relationships among different attribute names have a particular type, so as to represent various knowledge types, for examples combination of words and sentences, equations (operational equation, chemical equation or others), diagrams (map, historical diagram, anatomy diagram, arts type, sentence pattern of language and so on). The knowledge type determines how the knowledge symbol is used or operated.

When applied to an Internet community, for the knowledge symbols referred by the same community, it can be given relative addresses, such as “attribute 2/neighboring knowledge symbol/ . . . ”, or absolute address, such as “attribute 3/symbol of carrier 2/symbol of carrier 1”. However, a community name has to be also added in the address for denotation of different communities.

Each attribute (i.e., under the same attribute name) refers to a knowledge type, and the knowledge type, type of relationships (aggregation, combination, or others), context and corresponding knowledge processing unit are described in the knowledge attribute table.

Knowledge Processing

The operational functions of an e-brain are referred to the knowledge processing by using the carrier symbols and conceptual symbols on the knowledge map corresponding thereto. Typical knowledge processing comprises the following aspects.

(1) knowledge content: the conceptual symbol in a carrier symbol can be used to calculate the knowledge content in a specific carrier symbol, such as course materials, test base and database, so as to analyze the capability of the knowledge carrier, and to thereby provide suitable suggestions.

(2) knowledge searching: each carrier or conceptual symbol can be used as an index (e.g., keyword or key symbol) for searching the knowledge map for correlated carrier symbols, such as files, websites, discussion articles, course materials, questions, and so on.

(3) extended knowledge searching: in the searching of correlated information for a knowledge symbol, the up-knowledge symbol, the down-knowledge symbol and cross-knowledge symbol in the syntagmatic chain can be set up therefor.

(4) knowledge operation: the attribute value of a knowledge symbol can be operated or executed under a context in coincidence with a particular knowledge symbol, and the operation comprises computation, reasoning, problem-solving, description, presentation, and so on.

(5) cross-symbol knowledge operation: the various knowledge processing steps such as in the-above description, knowledge content, (extended) knowledge searching, knowledge operation, can be a combination of multiple steps for multiple symbols on the knowledge map, and a new knowledge symbol may be generated thereby.

(6) knowledge automation: the various knowledge processing steps such as in the-above description, knowledge content, (extended) knowledge searching, knowledge operation, cross-symbol knowledge operation, can be implemented by automation executed in a hardware and/or a software.

Implementation of an E-Brain

Implementation of an e-brain can be accomplished by a knowledge processor in either hardware or software approach.

The information technology as applied on the e-brain may be an algorithm (including data structure), knowledge base, neural network, genetic algorithm, and so on.

When software is used for practice, the knowledge map is expressed by variety kinds of software memories, such as data structures, files, databases, knowledge bases, hyperlinks, and so on. With hardware implementation, on the other hand, the knowledge map is expressed by variety kinds of hardware memories, such as memory chips, memory cards, secondary storage media (e.g., optical disks, floppies, hard disks, and so on).

In the software approach, the knowledge processor is represented by a server of knowledge maps, whereas the hardware approach has the knowledge processor represented by a knowledge chip such as a single chip or multiple chips, and may be practiced by a digital or analog form with electromagnetic, electro-optical, biochemical or other technology.

A knowledge processor may comprise several knowledge processing units, each of them is determined by a knowledge type as defined by a knowledge symbol, to interpret the attribute values of the corresponding knowledge symbols, in which knowledge interpreters are connected to servers of the corresponding knowledge maps to operate or process the attribute values. The attribute data sent to a knowledge interpreter of a particular knowledge type is represented by a format consistent with the knowledge instruction for example as
[knowledge operator] [parameter #1], [parameter #2], [parameter #n] (EQ-1),
where the knowledge operator corresponds to the attribute name and selects a particular knowledge interpreter in accordance with the knowledge type thereof, the parameter is an attribute value to be interpreted by the knowledge interpreter. Compared with the central processing unit (CPU) of computer system for executing the computation of data, the knowledge processor of the present invention executes the operation of knowledge.

The context of an attribute is set by the condition of the corresponding carrier symbol, as for an attribute of a knowledge symbol included in the carrier symbol, it is also determined by the carrier symbol. A context is equivalent to a control condition, and in an embodiment, the server of knowledge maps is responsible for its interpretation so as to make a decision on the execution of the attribute value (by sending to a knowledge interpreter).

The system as constructed based on the knowledge processing of the present invention can automatically execute a task as a computer system does, and higher level of knowledge, instead of data, is operated thereby.

Application of the E-Brain

An example for the purpose of education is provided herewith to illustrate the application of an e-brain, and it will be possible for one skilled in the art by the exemplatory teachings herewith to modify the example hereinafter to apply to other systems.

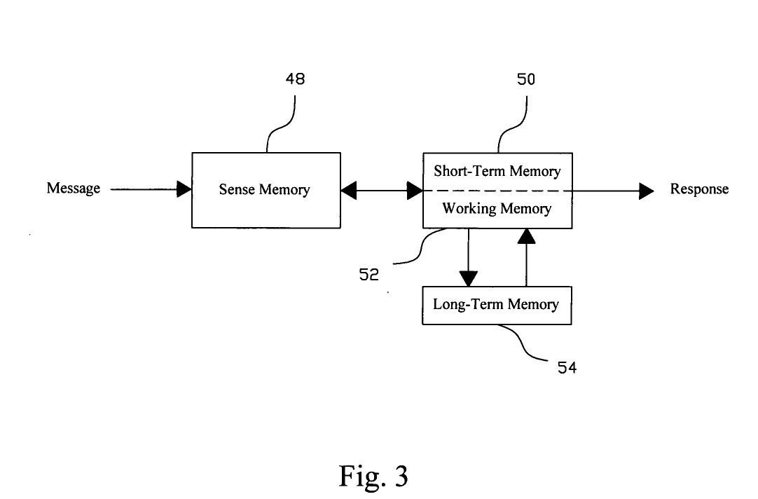

To illustrate how knowledge is used, there is provided in FIG. 3 an information processing model based on a memory system, which includes three major parts, sense memory 48, short-term memory (STM) 50 and long-term memory (LTM) 54. In this system, after the message into the sense memory 48, a serial of processing procedures will be conducted in the working memory 52, and the long-term memory 54 provides known knowledge that is essential during the processing procedures. The result as generated during the progress of knowledge processing is stored in the short-term memory 50, and a final result is generated via repeated processing, for responding to the inputted message. In addition, the knowledge obtained during the progress is added to the long-term memory 54 and therefore, the long-term memory 54 will accumulate knowledge through continuous stimulation and response. As a result, when knowledge is more diverse in the long-term memory 54, the response to a new stimulation is faster and the capability becomes better.

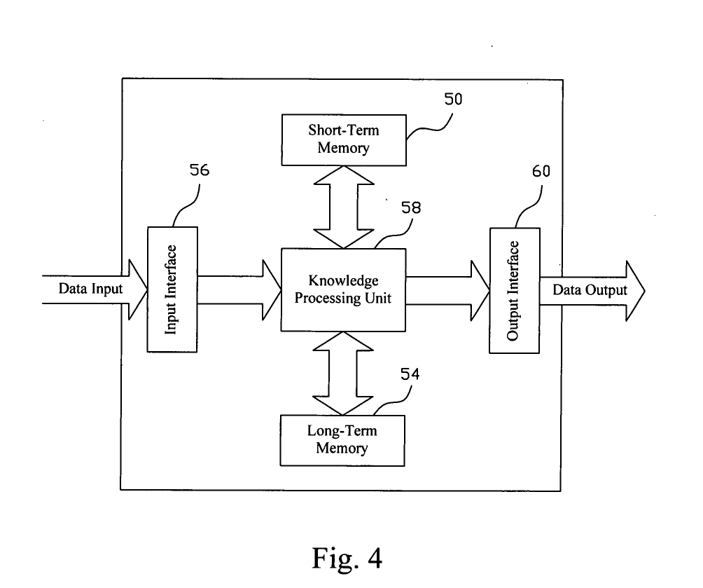

FIG. 4 shows a system block diagram of an e-brain application, which comprises a knowledge operation unit 58 as a core, and external data such as a course material or a question is delivered through an input interface 56 to the knowledge operation unit 58, where the knowledge operation is conducted with the help of the short-term memory 50 and the long-term memory 54, and the result finally generated is delivered out via an output interface 60. During the progress of knowledge operation, the inputted data from external is primarily transformed and processed by the knowledge operation unit 58 and then stored into the short-term memory 50, and among which, according to different information thereof, the knowledge operation unit 58 will search the long-term memory 54 for conceptual knowledge corresponding thereto and then combine that with the content in the short-term memory 50 so as to form a knowledge schema. In other words, the schema that is often used in cognitive psychology is utilized for knowledge construction in this system. This manner by repeated searching the long-term memory 54, accessing the short-term memory 50 and constructing and utilizing various knowledge schema, the inputted question will be solved or some results derived from the inputted course material will be outputted, and new knowledge thus generated is stored into the long-term memory 54.

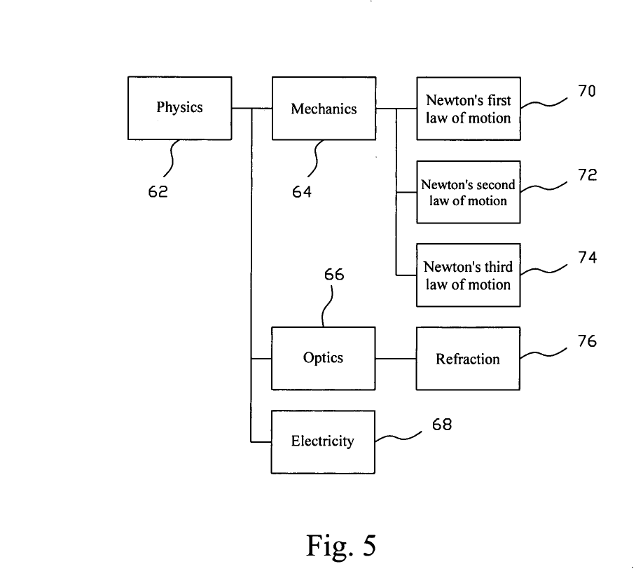

In this system, the degree of intelligence depends on the content of the knowledge base in the long-term memory 54, which includes the concepts and the relationships among the concepts. The data structure of this knowledge base is realized by a knowledge map as described in the above embodiment. FIG. 5 provides a knowledge map for physics to enhance the understanding of this scope. As in the afore-mentioned embodiment, each node in the hierarchy form hereof is a knowledge symbol and for convenience of explanation, the title is directly used to refer to the respective knowledge symbols. Physics 62 comprises mechanics 64, optics 66 and electricity 68, and each of them further comprises one or more knowledge symbols. As exemplified herewith, the mechanics 64 comprises Newton's Laws of Motion 70, 72 and 74, optics 66 comprises refraction 76, and others can be similarly deduced based thereon. The knowledge map can be expanded by learning and the process of learning is similar to that shown in FIG. 4. Moreover, this expansion of the knowledge map may result in increased knowledge (symbol) or relationship among the knowledge (symbols). In addition, the knowledge (symbols) in the knowledge map of this system can be modified or canceled.

When the system of FIG. 4 and the knowledge map of FIG. 5 are used to solve a physics problem, the problem will be analyzed and construed first. As an example, it is provided the original question:

A paratrooper undergone free-fall, displacement was 200 m, then the parachute was opened, the paratrooper undergone constant acceleration motion, acceleration was −2.0 m/s², upon landing of the paratrooper, velocity was 5.0 m/s, please determine the time that was spent by the paratrooper.

After the question is construed, it becomes:

[A paratrooper] <undergone> [free-fall], [displacement] <was> [200 m], <then> [the parachute was opened], [the paratrooper] <undergone> [constant acceleration motion], [acceleration] <was>[−2.0 M/s²], <upon> [landing of the paratrooper], [velocity] <was> [5.0 m/s], <please determine> [the time] <that was spent by> [the paratrooper].
   In this manner, the question is transformed and processed by the knowledge operation unit 58 and is then stored into the short-term memory 50, concepts that are correlated to the question are all dug out from the knowledge map of FIG. 5, followed by knowledge processing as in the procedure of the foregoing embodiment. In detail, during the progress of processing, the question is pre-transformed into several knowledge instructions for example in the format of equation EQ-1, and the knowledge operators and parameters thereof are determined by corresponding knowledge attribute table, by which the first three sentences of the above question can be transformed for example into the following knowledge instructions:
newConcept schema{1}, start
newConcept schema{2}, paratrooper
newConcept schema{3}, free-fall, schema{2}
ownRelation schema{3}, paratrooper, undergone, free fall
aggregate temp1, 200, m
newConcept schema{4}, displacement, temp1
newConcept schema{5}, then, the parachute was opened

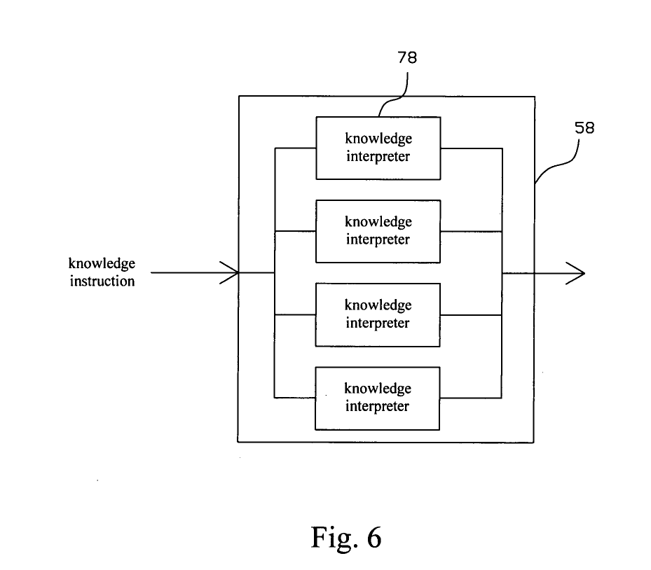

FIG. 6 shows the internal composition of a knowledge operation unit 58, which comprises a plurality of knowledge interpreters 78 corresponding to the respective knowledge type of the knowledge instructions, to be properly selected by their knowledge type to execute the knowledge operation such as computation, reasoning, problem-solving, description and presentation, according to the context of the knowledge instructions, and the execution of one knowledge instruction may comprise reading more knowledge instructions from the short-term memory 50 to be executed. Obviously, a task can be automatically executed by this system and method. In particular, in this system and method, the knowledge map shows an appreciable degree of intelligence that a concept not revealed in the original question can even be searched, used or operated under a particular context during the progress of knowledge operation because of the relationships among the concepts, and furthermore, the concepts and the correlations among the concepts in the knowledge map will be diversified by the knowledge operation.

This system and method can be utilized for solving particular problems in various fields, for instance, to replace a teacher in an educational system through tutoring a student's learning and evaluating the achievement. By integration of the Internet technology, an e-brain can be an intelligent agent to overcome the limitation of time and space.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

1. An e-brain comprising:
a knowledge map configured in a hierarchy form with each node thereof being a knowledge symbol having a knowledge attribute table for recording one or more attributes each containing an attribute name and an attribute value;
a knowledge instruction including a knowledge operator and one or more parameters determined by the attribute name and attribute value, respectively; and
a knowledge interpreter corresponding to the attribute name for interpreting the attribute value.

2. The e-brain of claim 1, wherein the knowledge map is provided by a server.

3. The e-brain of claim 1, wherein the knowledge map is derived from an algorithm.

4. The e-brain of claim 1, wherein the knowledge map is derived from a genetic algorithm.

5. The e-brain of claim 1, wherein the knowledge map is stored in a neural network.

6. The e-brain of claim 1, wherein the knowledge map is stored in a file.

7. The e-brain of claim 1, wherein the knowledge map is stored in a memory.

8. The e-brain of claim 1, wherein the knowledge map is provided by accessing a hyperlink.

9. The e-brain of claim 1, wherein the knowledge interpreter is implemented by a program.

10. The e-brain of claim 1, wherein the knowledge interpreter is implemented by a single chip.

11. The e-brain of claim 1, wherein the plurality of knowledge symbols includes a carrier symbol.

12. The e-brain of claim 11, wherein the knowledge instruction is executed for searching the knowledge map for a second carrier symbol in accordance with the first carrier symbol.

13. The e-brain of claim 1, wherein the plurality of knowledge symbols includes a conceptual symbol.

14. The e-brain of claim 13, wherein the knowledge instruction is executed for searching the knowledge map for a carrier symbol in accordance with the conceptual symbol.

15. The e-brain of claim 1, wherein the plurality of knowledge symbols includes a carrier symbol vehicling a conceptual symbol for calculating a knowledge content of the carrier symbol or a second carrier symbol.

16. The e-brain of claim 1, wherein the attribute further includes a context.

17. The e-brain of claim 16, wherein the attribute value is operated under the context.

18. The e-brain of claim 17, wherein the operation of the attribute value is selected from the group composed of computation, reasoning, problem-solving, description and presentation.

19. The e-brain of claim 1, wherein the knowledge map includes one of the plurality of knowledge symbols derived from a knowledge operation of another one or more knowledge symbols thereof.

20. A data structure comprising:
a knowledge map including a plurality of knowledge symbols configured in a hierarchy form with each node thereof corresponding to one of the plurality of knowledge symbols;
each of the plurality of knowledge symbols having a knowledge attribute table for recording one or more attributes each representing one set of signified description thereof; and
each of the plurality of nodes in the hierarchy form having a unique addressing expression for the corresponding knowledge symbol thereto.

21. The data structure of claim 20, wherein each of the plurality of knowledge symbols includes a string, a numeral, a graphic, an image, a visual information, an animation or any representative symbol referring to other object or intention on a computer or internet, or a combination thereof.

22. The data structure of claim 20, wherein each of the plurality of attributes has an attribute name and an attribute value.

23. The data structure of claim 20, wherein the plurality of knowledge symbols includes at least one knowledge symbol appears on two or more of the plurality of nodes in the hierarchy form.

24. The data structure of claim 20, wherein the plurality of knowledge symbols includes at least one knowledge symbol being a carrier symbol.

25. The data structure of claim 24, wherein the carrier symbol vehicles one or more knowledge symbols thereon.

26. The data structure of claim 24, wherein the carrier symbol serves as a guiding unit for guiding a switching between the plurality of knowledge symbols on the knowledge map.

27. The data structure of claim 20, wherein the plurality of knowledge symbols includes at least one knowledge symbol being a conceptual symbol.

28. The data structure of claim 27, wherein the conceptual symbol includes at least one signifier.

29. The data structure of claim 20, wherein the knowledge map has a title.

30. The data structure of claim 29, wherein the title is a root name of the hierarchy form.

31. The data structure of claim 20, wherein each of the plurality of knowledge symbols has a syntagmatic chain with an up-knowledge symbol thereof.

32. The data structure of claim 31, wherein the syntagmatic chain is inclusion, inheritance, amount or location.

33. The data structure of claim 32, wherein the amount or location is depicted in the knowledge attribute table.

34. The data structure of claim 22, wherein one of the plurality of knowledge symbols has its attribute value with a signified description representing a combinational relationship among two or more of the plurality of knowledge symbols.

35. The data structure of claim 34, wherein the combinational relationship has a specific form representing a knowledge type.

36. The data structure of claim 35, wherein the knowledge type is a combination of words and sentences, an equation or a diagram.

37. The data structure of claim 20, wherein each of the plurality of attributes has a context.

38. The data structure of claim 20, wherein each of the plurality of attributes has a corresponding knowledge processing unit.

39. The data structure of claim 20, wherein each of the plurality of knowledge symbols has a unique addressing expression corresponding thereto.

40. The data structure of claim 39, wherein the unique addressing expression forms a tree structure.

41. A knowledge processing method comprising the steps of:
preparing a knowledge map configured in a hierarchy form with each node thereof being a knowledge symbol having a knowledge attribute table for recording one or more attributes each containing an attribute name and an attribute value;
interpreting a knowledge instruction including a knowledge operator and one or more parameters determined by the attribute name and attribute value, respectively; and
operating the attribute value under a context.

42. The method of claim 41, further comprising searching the knowledge map for a first carrier symbol, a second carrier symbol or a conceptual symbol in accordance with the first carrier symbol.

43. The method of claim 41, further comprising searching the knowledge map for a first conceptual symbol, a second conceptual symbol or a carrier symbol in accordance with the first conceptual symbol.

44. The method of claim 41, further comprising calculating a knowledge content of a carrier symbol in accordance with a conceptual symbol.

45. The method of claim 41, wherein the step of operating the attribute value includes a computation, a reasoning, a problem-solving, a description or a presentation.

46. The method of claim 41, wherein the step of operating the attribute value includes generating a new knowledge symbol from one or more of the plurality of knowledge symbols.

47. The method of claim 46, further comprising arranging the new knowledge symbol on the knowledge map.

48. The method of claim 41, further comprising modifying or canceling one or more of the plurality of knowledge symbols on the knowledge map.

49. A knowledge instruction comprising:
a knowledge operator; and
one or more parameters following behind the knowledge operator for being operated by the knowledge operator.

50. The knowledge instruction of claim 49, wherein the knowledge operator corresponds to a knowledge type.

51. The knowledge instruction of claim 50, wherein the one or more parameters are attribute values of a knowledge symbol having an attribute name corresponding to the knowledge type.

52. A knowledge processor comprising:
an input for receiving a knowledge instruction;
one or more knowledge interpreters connected to the input with each knowledge interpreter thereof interpreting an attribute value for a knowledge symbol of a knowledge type; and
an output connected to the one or more knowledge interpreters for outputting a knowledge operation result.
